(19) United States
(12) Patent Application Publication
(10) Pub. No.: US 2013/0007635 A1
(43) Pub. Date: Jan. 3, 2013

(54) TELECONFERENCING ADJUNCT AND USER INTERFACE TO SUPPORT TEMPORARY TOPIC-BASED EXCLUSIONS OF SPECIFIC PARTICIPANTS

(75) Inventors: Paul Roller Michaelis, Louisville, CO (US); Ganesh Ananthakrishnan, Broomfield, CO (US)

(73) Assignee: AVAYA INC., Basking Ridge, NJ (US)

(21) Appl. No.: 13/174,279

(22) Filed: Jun. 30, 2011

(51) Int. Cl. G06F 3/01; G06F 15/16

(52) U.S. Cl. 715/753

(57) ABSTRACT

An aspect associates people participating in a conference with one or more specific topics. This association can limit a particular participant's participation to specific topic(s) they are associated with, the one or more media streams for the other topics excluded from viewing and/or listening. For example, if a participant is to provide a presentation for Item 4, and that is the only item the participant should be participating in, that participant could be allowed to join the conference with a status message being provided to the participant as the conference progresses through Items 1-3. An “on-deck” message can be provided to the meeting participant indicating their agenda item is almost ready for discussion, and when Item-4 is selected to be discussed, the participant is provided with one or more appropriate media streams for the conference. The media for the other media streams blocked from the participant for the other items.

### BACKGROUND

Mechanisms exist that allow the transmissions to specific individuals to be blocked during a conversation. The typical example is the so-called side-bar function in which a private conversation may be established among a subset of individuals who are participants in a conference. The discussion within the side-bar group is not heard or seen by people who are not members of that group. Similarly, it is possible to distribute text messages to specific individuals who are participating in a conference.

### SUMMARY

In teleconferences and collaborative sessions, it is often desirable to block person A's access to data X, person B's access to data Y, person C's access to data Z, and so on. However, a problem exists in that there is no automatic synchronization among different media in multi-media sessions, such that a person who is unauthorized to see such data is blocked from hearing or seeing that data discussed.

At a high level, it is known that there are mechanisms to block and unblock audio, video and text transmissions to specific individuals and also allow participant-specific filtration of data contained within documents. However, and as discussed, these blocking and unblocking mechanisms are not synchronized. Specifically, when information is to be shared in a conference, and a pre-defined subset of conference participants is not authorized to learn about that information or monitor the discussion, there is no user-friendly way to synchronize the temporary blocking of all or a portion of the media streams to those individuals.

On exemplary aspect of the disclosed techniques is to provide a user-friendly teleconference adjunct that is able to block the transmission of one or more media streams to specific subsets of participants when information is being exchanged that those subsets of participants are not authorized to acquire.

In one exemplary aspect, for conference participants who have appropriate permissions, typically, but not necessarily, the conference host will see a document of some sort on their display. The document could take many forms such as a spreadsheet, a PowerPoint® slide deck, a graphical user interface, or a simple text-only agenda in which the topics to be discussed are listed separately. Prior to the meeting, components of the document that are linked to topics or data that should not be shared among all participants can be identified, and then tagged with who is, or is not, allowed to access that information. Illustratively, during the meeting, if a conference participant who has control privileges “mouses-over” or otherwise clicks a component of the document that is linked to information that persons A, B, and C are not permitted to acquire or view, this would signal the conference server/adjunct to block one or more media transmissions to A, B and/or C until the re-transmissions are re-enabled by, for example, an authorized party or automatically enabled based, for example, on the ending of the agenda item that was not to be shared. Similar control, via, for example, an enterprise desktop communications device, could be achieved via appropriate touches of the screen, or comparable interface inputs.

In accordance with another exemplary embodiment, features that may be included with the techniques disclosed herein include:
A conference-control user interface that allows person-specific permissions for each topic to be maintained and edited during the conference;
The conference-control user interface allowing new topics, and associated person-specific permissions, to be added to the control document, and;
Conference control can be achieved via speech or text recognition, such that the transmissions to specific individuals could be blocked immediately upon detection that an un-authorized topic had come up.

Other exemplary aspects relate to real-time conference moderator control dissemination of information via one or more media streams to one or more conference participants. As discussed, this could be enabled through a graphical user interface provided to a conference moderator and/or entity participating in the conference.

Other exemplary aspects are directed toward when a conference participant is excluded from certain subject matter, that conference participant being provided with one or more of hold music, status message(s), text feedback, and/or the ability to conduct an additional conference call(s) such as a sub-conference call.

Another exemplary embodiment is directed toward automatically performing content/context recognition, for example, with the cooperation of a speech-to-text converter that allows the system to automatically exclude certain meeting participants based on one or more rules when particular content/context is detected. As will be appreciated, there may be different permissions for different people, as well as a triggering event to determine when to exclude certain meeting participants from hearing certain information based on time, optionally in addition to agenda items.

An additional aspect is directed toward associating certain people participating in a conference with specific topics. This association can limit a particular participant's participation to a specific topic(s) they are associated with with one or more media streams for the other topics being excluded from viewing and/or listening. For example, if a conference participant is to provide a presentation for “Agenda Item-4,” and that is the only presentation the participant should be participating in during the conference, that participant could be allowed to join the conference with for example, a status message provided to the participant as the conference progresses through agenda items 1-3. An “on-deck” message can be provided to the meeting participant indicating their agenda item is almost ready for discussion, and when Agenda Item-4 is selected to be discussed, the participant is provided with one or more appropriate media streams for the conference.

In accordance with yet another exemplary embodiment, portions of the media streams for a particular participant in a conference can be limited based on, for example, the subject matter contained therein. As an example, if conference participant Pat is receiving audio, video, white-boarding and text chat associated with a conference, any one or more of these streams could be excluded from her viewing or hearing during one or more portions of the conference. For example, Pat could be provided with all of the audio, video and chat associated with the conference, however when a particular person was whiteboarding a particular diagram, that could be excluded from her view. For example, and based on one or more rules, the conference system can analyze who is drawing on the whiteboard, and recognizing a rule which states that only 2 people, not including Pat, are able to view what that person draws on the whiteboard, the system can automatically remove from view, e.g., by not providing the media stream for the white board to Pat's conference interface.

In accordance with another exemplary embodiment, a conference bridge or switch operates with an artificial intelligence module. It monitors, for example in real-time, the topics being discussed during the conference, and based on context and/or content recognition, dynamically regulates which conference participants are to receive which one or more of the media streams associated with the conference.

In accordance with yet another exemplary embodiment, an interactive graphical user interface is provided to, for example, a conference moderator that allows the one or more media streams to be dynamically controlled for the one or more conference participants. For example, an interface can be provided such that beside each participants' name is a list of the available streams that can be provided to that conference participant with an indication beside the one or more streams as to whether that stream is currently enabled for that participant. On an even more granular level, a menu, such as a drop-down menu, could be provided that allows the conference moderator to select which agenda items during the conference the conference provider should be provided access to, or alternatively, excluded from. As is to be appreciated, standard graphical user interface selectable items can be used with the techniques disclosed herein including, but not limited to, one or more of radio buttons, drop down menus, check boxes, expandable menus, and the like. As will be appreciated, information regarding the various participants and optionally templated rules can be pre-populated into the interface for example upon registration of the one or more conference participants.

It should also be appreciated that one or more graphics could be associated with the one or more conference participants that assist a conference moderator with more quickly identifying which media streams are or are not being provided to a particular conference participant at any point in time. For example, icons could be used that represent one or more of the multimedia streams, such as audio, video, whiteboarding, chat, and the like, in addition to, or as an alternative to the textual-based indicators shown herein in accordance with any exemplary embodiment.

In accordance with another exemplary embodiment, the permission information can be assigned before the conference, the dynamic enabling/disabling is performed based on detected content in the conference, and/or the permission information can be set by a moderator to include one or more of read access, write access, copy access, view only access, full access and in general any type of access (including the exclusion of access).

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any non-transitory, tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, DVD, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, this disclosure is considered to include a tangible storage medium or distribution medium and prior art-recognized equivalents and successor media, in which the software implementations of the present embodiments are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the embodiments are described in terms of exemplary embodiments, it should be appreciated that individual aspects of the embodiments can be separately claimed.

The preceding is a simplified summary of the embodiments to provide an understanding of some aspects of thereof. This summary is neither an extensive nor exhaustive overview of the various embodiments. It is intended neither to identify key or critical elements of the embodiments nor to delineate the scope of the embodiments but to present selected concepts of the embodiments in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The exemplary embodiments disclosed herein will be discussed with relation to the figures wherein:

FIG. 1 illustrates an exemplary operating system;

FIG. 2 is a flowchart outlining an exemplary method for participant management; and

FIG. 3 is a flowchart outlining an exemplary method for managing media streams to one or more conference participants during a conference.

### DETAILED DESCRIPTION

The techniques will be illustrated below in conjunction with an exemplary electronic system, such as a conferencing or communications system. Although well suited for use with, e.g., a system using a computer/electronic device, server(s), communications devices, touch-screen mobile devices, and/or database(s), the embodiments are not limited to use with any particular type of electronic device(s) or system or configuration of system elements. Those skilled in the art will recognize that the disclosed techniques may be used in any application in which it is desirable to provide enhanced collaboration and communication capabilities.

The exemplary systems and methods will also be described in relation to software (such as drivers), modules, and associated hardware. However, to avoid unnecessarily obscuring the present disclosure, the following description omits well-known structures, components and devices that may be shown in block diagram form, are well known, or are otherwise summarized.

For purposes of explanation, numerous details are set forth in order to provide a thorough understanding of the embodiments. It should be appreciated, however, that the techniques disclosed herein may be practiced in a variety of ways beyond the specific details set forth herein.

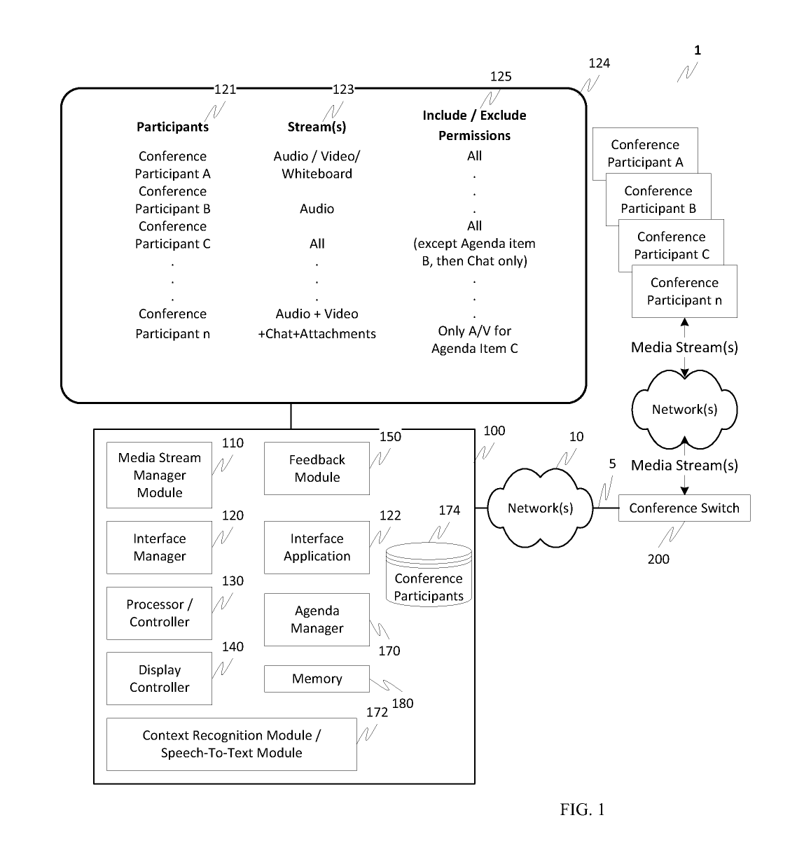

FIG. 1 illustrates an exemplary conference system 1. In addition to well known componentry, the conference system 1 includes an information management system 100 connected via one or more networks 10 and links 5 to one or more conference participants (illustrated as conference participant A through conference participant n) and conference switch 200. Associated with the information management system 100 is an interface 124, such as a graphical user interface that includes information such as participant's 121, streams 123, and include/exclude permissions 125.

The information management system 100 comprises a media stream manager module 110, an interface manager 120, processor/controller 130, display controller 140, feedback module 150, interface application 122, agenda manager 170, memory 180, conference participant storage/database 174, and context recognition module/speech-to-text module 172.

The conference switch 200 can be any suitable conference switch or server such as a 1056-port CS700 and CS780 conferencing server™ of Avaya, Inc. The conference switch/server typically includes conferencing bridge functionality, one or more conferencing applications, and associated hardware, such as Multipoint Conferencing Units™ (MCU), Unified Conferencing™, Web Conferencing™, IV Office Conferencing™, and/or Meeting Exchange™ of Avaya, Inc. These products typically require the participants to dial into a conference bridge using a predetermined dial-in number and access code to initiate conference sessions, without an operator or advanced operations.

As will be appreciated, these products further provide integrated features such as audio and web conference sessions management, PowerPoint™ push, document annotation and other annotation tools, text chat, desktop and application sharing, polling with instant tabulation, interactive whiteboard sessions and conference session recording and playback of audio and web portions of the conference session. The products also enable streamed video from one or more presenters, such as using a web cam and provide a roster display of participants, a discussion window that provides keyboard chatting that can be private between participants or broadcast and visible to all participants, a capability that enables a host to promote a participant to host status so that participant can control the conference session, recording and playback of audio and web portions of the conference session and LDAP integration of corporate directories and databases. The host can identify speakers, mute selected or all participants, (forcibly) disconnect selected participants, start and stop synchronized recording of the conference session, and synchronize recording of combined web and audio streams. The conferencing application can provide conference session security by means of a conference session URL and security code.

As will be appreciated, all or a part of the functionality of the conference switch/server can be included within the information management system 100 and/or associated with one or more of the networks 10.

The term “conference” or “conference session” refers to a single or multimedia voice call or other type of session among 3 or more parties. As will be appreciated, the conference session can be circuit- or packet-switched. Any a suitable protocol can be used, such as a digital control protocol, H.323, the Session Initiation Protocol (SIP), Media Gateway Control Protocol (MGCP), Real-Time Transport Protocol (RTP) and Session Description Protocol (SDP).

The term whiteboard or electronic blackboard refers to a common area between applications and users in which mutually exchanged information is stored in a standard form that all conference session participants can access in accordance with the permissions discussed herein. Moreover, the information management system 100 can include or be associated with a PBX, an enterprise switch, an enterprise server, or other type of telecommunications system, switch or server. Each conference participants (conference participant A—conference participant n) can be associated with any communications device(s) such as IP-capable hard- or soft-phone and/or digital telephone that may be optionally modified to perform the operations and techniques disclosed herein. Examples of suitable Avaya® model telephones include the 1600™, 2400™, 4600™, 5400™, 5600™, 9600™, 9620™, 9630™, 9640™, 9640G™, 9650™, Quick Edition™ telephones, IP wireless telephones, video phones and soft phones. Moreover, the one or more conference participants can be associated with any suitable circuit- or packet-switched or digital (e.g., TDM-enabled) communications device(s). Examples include wired and wireless telephones, personal digital assistants or PDAs, personal computers or PCs, laptops, packet-based H.320 video phones and conferencing units, packet-based voice messaging and response units, peer-to-peer based communication devices and packet-based traditional computer telephony adjuncts.

The interface 124, such as a graphical user interface, can be displayed, for example, on a display such as a computer display with the cooperation of the display controller 140 that can be manipulated via one or more input means, such as a keyboard, mouse, touch screen, or the like.

In accordance with yet another exemplary embodiment, the conference moderator or other entity that is in charge of controlling which participants receive and do not receive the various media streams associated with a conference is also provided with information indicating the capabilities of the end-point associated with the participant. These capabilities can be displayed, for example, in the interface 124 in association with the participant information 121, stream information 123, and permission information 125. For example, if a user only has an audio-enabled end-point, the graphical user interface for that participant could be simplified such that the moderator only need worry about permissions associated with the audio media stream, and none of the other streams since they are not available to that participant. The capabilities of the end-point can be queried upon commencement of the conference, can be associated with a profile associated with the participant, or be determined based on the results of a query to the actual participant.

In accordance with an optional exemplary embodiment, a conference profile can be stored that contains information such as the participant information 121, stream information 123, and permission information 125, such that it can be used as a template for restricting the dissemination of information in future conferences.

In operation, a conference usually commences with the sending out of various invitations to the people who will be conference participants. Upon acceptance of the invitation, the conference participants can be provided information such as dial in number, password, time, date, length of conference, and various other information related to the conference. As will be appreciated, attachments can also accompany the invitation. The attachments can be one or more of documents, presentations, multimedia presentations and in general any information associated with the conference for which the invitations were sent.

In accordance with an optional embodiment, the invite information can be forwarded to the agenda manager 170 and conference participant storage 174 such that the information management system 100 stores the conference information including, but not limited to, date, time and participants. This can, for example, provide the moderator the opportunity to begin to assign stream and permission information prior to the actual conference taking place. Also storable with this information can be information about which media streams are expected to be used during the conference.

At the scheduled time of the conference, the conference participants dial in or otherwise connect to the conference and optionally enter a password, at which point and with the cooperation of the conference switch 200, are joined to the conference. As each conference participant joins the conference, and in cooperation with the agenda manager 170, the participant is registered and an indication that the participant is present stored in the conference participant storage 174.

In accordance with one exemplary embodiment, as each participant is added, agenda information can be reconciled and associated with that particular participant(s). For example, information such as whether the participant is providing the agenda item, whether the participant is a “listener” to the agenda item, or whether the participant is expected to participate in the agenda item, can be used to assist with assigning participant permissions to that agenda item.

At a high level, and independent of agenda items, permissions can be established for one or more participants, such as the granting of access to all streams, the exclusion of access to all streams, or some combination thereof. On a more granular level, permissions associated with the various streams associated with the conference can be restricted to a particular agenda item, or even a portion thereof. Thus, the level of granularity associated with permissions is scalable such that any portion of information associated with a conference can have permissions associated therewith that restrict the dissemination thereof. It should also be appreciated, the assigning permissions can be dynamic, such that, for example, if a document is introduced mid way through the conference, and that document was not part of a pre-configured agenda, permissions regarding the dissemination of that document can be immediately assigned, via, for example, a pop-up window, such that the document is restricted from one or more participants. As discussed, this permission information can be populated prior to the commencement of a conference, during a conference, in real-time, or any combination thereof.

At a point in time after the joining of one or more of the conference participants, and in cooperation with the media stream manager module 110, processor/controller 130, memory 180, networks 10, links 5, and conference switch 200, the various media streams associated with the conference begin streaming. In conjunction with the commencement of media streaming and utilizing one or more of media channel permission information and agenda item permission information, the media stream manager module 110, cooperating with the agenda manager 170, and conference participant storage 174 reads the permissions associated with each participant and limits the streams to that participant based on the associated permission information.

At any point a participant, such as a moderator, can manually override the permission information and limit the streams associated to one or more of the conference participants by interacting with interface 124 in cooperation with the interface manager 120 and display controller 140. As discussed, various tools can be provided to the moderator or other conference participants that allow ease of access to control, edit and delete permission information associated with the one or more participants—the permission information being editable on an individual, group, or global basis.

As the various media streams are turned on and off for the various conference participants, and in cooperation with the optional feedback module 150, feedback information can be provided to the conference participants. This feedback information can include information such as (textually, graphically and/or audibly) “This portion of the conference is currently not available,” or other information provided to a conference participant when certain media streams are not available. This information can include one or more of hold music, status information, such as where in an agenda the conference currently is and the expected time before the conference participant is again provided access to the one or more media streams, or alternative communication modalities provided to one or more of the excluded participants, such as a chat window, whisper channel, or in general any known communication modality. These additional communication modalities can also be limited in accordance with the permission information 125 and restricted by, for example, the moderator.

In addition to the media stream manager module 110 being able to dynamically turn on and off the various media streams based on media channel permission information, the media stream manager module 110, cooperating with the agenda manager 170, can control the turning on and off of the various media streams based on agenda item information. For example, one or more of the agenda items associated with a conference can be identified in the permissions 125 such that each agenda item, or portion thereof, can have specific permissions associated therewith. This allows, for example, very granular management of the various streams associated with a conference.

As an agenda item is completed, for example, based on an indication from the moderator or the conference participant moderating that particular agenda item, the media stream manager module 110, cooperating with the agenda manager 170, determines the permissions associated with the next agenda item and dynamically modifies which conference participants are to receive which conference stream information until all agenda items are complete.

In accordance with an optional exemplary embodiment, and in cooperation with the context recognition module/speech-to-text module 172, the media stream manager 110, again cooperating with the agenda manager 170 and permissions stored in the conference participant storage 174, monitors, for example, in real-time, information being exchanged within the conference (optionally in cooperation with the speech-to-text module) and compares this information to the permission information. In accordance with this exemplary embodiment, the permission information is even more granular and directed to particular content, such as a key word(s), specific document, specific multi-media presentation, or the like. On this content being introduced to the conference, the context recognition module 172, in cooperation with the media stream manager module 110, and based on the permission information 125 can limit the dissemination of this information to the various conference participants.

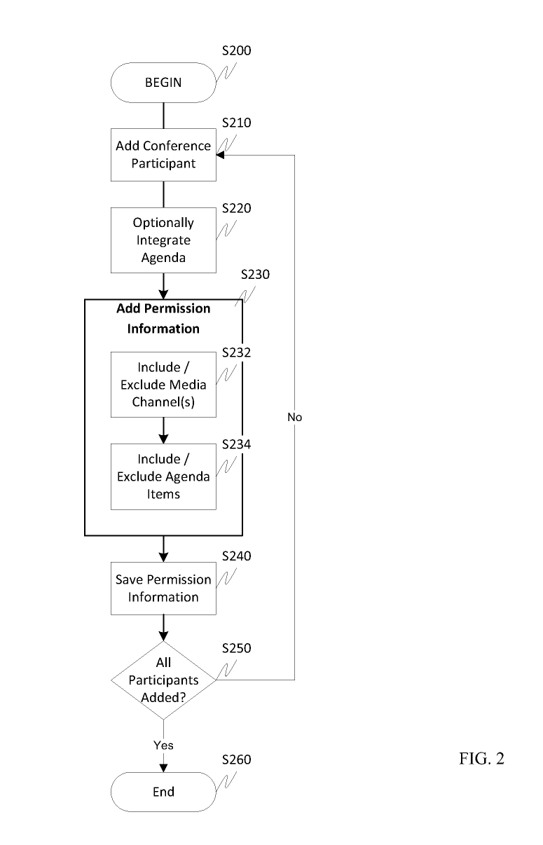

FIG. 2 outlines an exemplary method for assigning permission information. In particular control begins in step S200 and continues to step S210. In step S210, a conference participant is added. Next, in step S220, agenda information can optionally be integrated and associated with a scheduled conference. Then, in step S230, permission information is added. More particularly, in step S232, the inclusion or exclusion of media channels for the conference participant is identified. Then, in step S234, the inclusion or exclusion of agenda items within the conference can also have permissions assigned thereto, with control continuing to step S240.

In step S240, the permission information is saved. Next, in step S250, a determination is made as to whether all participants have been added. If all participants have not been added, control jumps back to step S210 with control otherwise continuing to step S260 where the control sequence ends.

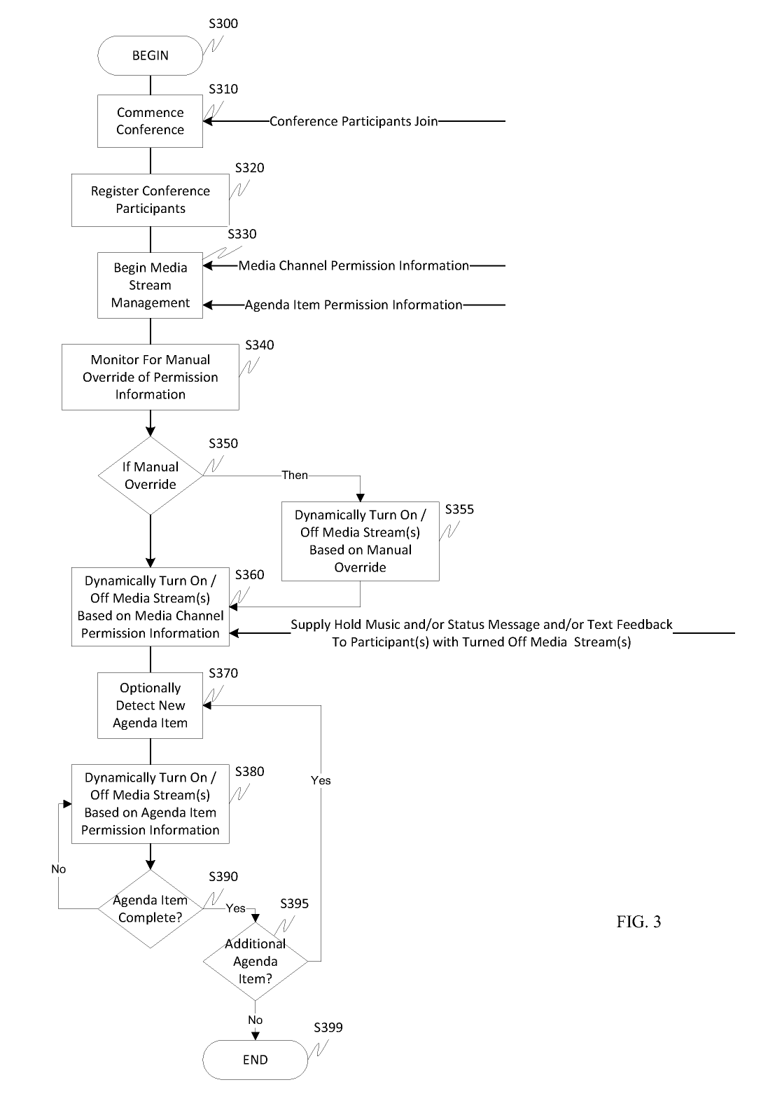

FIG. 3 outlines an exemplary method for managing media streams within a conference. In particular, control begins in step S300 and continues to step S310. In step S310, a conference commences. As the conference commences, various conference participants join the conference with in step S320 joining of a participant being registered with the system. Control then continues to step S330.

In step S330, the media stream management commences based on information regarding media channel permissions as well as optionally agenda item permissions. Next, in step S340, at any point during the conference, manual over-riding of the permission information can be monitored. If, in step S350, a manual over-ride is detected, control then continues to step S355, with control otherwise jumping to step S360.

In step S355, various media streams can be dynamically turned on or off based on the manual override. As discussed, this manual override can be specific to one participant, a group of participants, or be applied globally.

In step S360, the various media streams are dynamically turned on or off based on the media channel permission information associated with each participant. As discussed, and in accordance with an optional exemplary embodiment, this can be accompanied with the supplying of hold music and/or status messages and/or text feedback to the participants that have the turned off media streams. This optional information can be provided on a per-participant basis, to a group of participants, or supplied globally to all the conference participants or all the conference participants with turned-off media stream(s). Control then continues to step S370.

In step S370, and if an agenda is being used with the conference, a new agenda item can be detected. As discussed, this can be based on received input from one or more of a moderator or conference participant, or, for example, be triggered based on reaching a certain point in time. Next, in step S380, the one or more media streams can be dynamically turned on or off based on the agenda item permission information for the one or more conference participants. Then, in step S390, a determination is made whether the agenda item is complete. If the agenda item is not complete, control jumps back to step S380 with control otherwise continuing to step S395.

In step S395, a determination is made as to whether additional agenda items are present. If additional agenda items are present, control jumps back to step S370, with control otherwise continuing to step S399 where the control sequence ends.

While the above-described flowcharts have been discussed in relation to a particular sequence of events, it should be appreciated that changes to this sequence can occur without materially effecting the operation of the embodiments. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols herein can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques herein.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems described herein is dependent on the speed and/or efficiency requirements of the system, the particular function, and the particular software or hardware systems or microprocessor or microcomputer systems being utilized. The security systems, methods and protocols illustrated herein can be readily implemented in hardware and/or software using any known or later developed systems or structures, devices and/or software by those of ordinary skill in the applicable art from the functional description provided herein and with a general basic knowledge of the computer and security arts.

Moreover, the disclosed methods may be readily implemented in software that can be stored on a non-transitory storage medium, executed on a programmed general-purpose computer with the cooperation of a controller and memory, a special purpose computer, a microprocessor, or the like. In these instances, the systems and methods described herein can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided systems, apparatuses and methods for facilitating exchange of information in a conference environment. While the embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A method for managing information in a conference environment comprising:
assigning permission information to one or more media streams for a conference, the permission information associated with one or more conference participants; and
dynamically enabling/disabling one or more of the one or more media streams during the conference based on the permission information, wherein disabled media streams are not accessible to a conference participant.

2. The method of claim 1, further comprising providing feedback to the conference participant while a media stream is disabled.

3. The method of claim 1, wherein permissions are also assigned based on agenda item information, and are capable of being assigned before the conference.

4. The method of claim 1, further comprising providing an editable interface that allows management and editing of the permission information.

5. The method of claim 1, further comprising monitoring content in a conference and dynamically enabling/disabling one or more of the one or more media streams to one or more of the conference participants during the conference based on the content.

6. The method of claim 1, further comprising detecting an override of the permission information and dynamically enabling/disabling one or more of the one or more media streams to one or more of the conference participants based thereon.

7. The method of claim 1, wherein the conference is a multimedia conference or a teleconference.

8. The method of claim 1, wherein the media streams are one or more of audio, video, whiteboard, document, attachment, chat, whisper channel, and text.

9. The method of claim 1, further comprising performing speech-to-text conversion of one or more portions of the conference.

10. A non-transitory computer-readable information storage media having stored thereon processor-executable instructions capable of performing the steps of claim 1.

11. A system that manages information in a conference environment comprising:
a interface manager that allows for the assigning of permission information to one or more media streams for a conference, the permission information associated with one or more conference participants; and
a media stream manager and processor that dynamically enable/disable one or more of the one or more media streams during the conference based on the permission information, wherein disabled media streams are not accessible to a conference participant.

12. The system of claim 11, further comprising a feedback module that provides feedback to the conference participant while a media stream is disabled.

13. The system of claim 11, wherein permissions are also assigned based on agenda item information.

14. The system of claim 11, further comprising a display controller that provides an editable interface that allows management and editing of the permission information.

15. The system of claim 11, further comprising a context recognition module that monitors content in a conference and dynamically enables/disables one or more of the one or more media streams to one or more of the conference participants during the conference based on the content.

16. The system of claim 11, wherein an override of the permission information is detected and dynamic enabling/disabling of one or more of the one or more media streams to one or more of the conference participants is performed based thereon.

17. The system of claim 11, wherein the conference is a multimedia conference or a teleconference.

18. The system of claim 11, wherein the media streams are one or more of audio, video, whiteboard, document, attachment, chat, whisper channel, and text.

19. The system of claim 11, further comprising a speech-to-text module that performs speech-to-text conversion of one or more portions of the conference.

20. The system of claim 1, wherein:
the permission information is assigned before the conference;
the dynamic enabling/disabling is performed based on detected content in the conference; and
the permission information can be set by a moderator to include one or more of read access, write access, copy access, view only access and full access.
